(19) United States
(12) Patent Application Publication
(10) Pub. No.: US 2011/0228663 A1
(43) Pub. Date: Sep. 22, 2011

(54) HOLOGRAPHIC RECORDING METHOD

(75) Inventors: Masaya Terai, Kanagawa-ken (JP); Kazuki Matsumoto, Kanagawa-ken (JP); Rumiko Hayase, Kanagawa-ken (JP); Yoshiaki Kawamonzen, Tokyo (JP); Norikatsu Sasao, Tokyo (JP); Masahiro Kanamaru, Kanagawa-ken (JP)

(73) Assignee: KABUSHIKI KAISHA TOSHIBA, Tokyo (JP)

(21) Appl. No.: 12/880,828

(22) Filed: Sep. 13, 2010

(30) Foreign Application Priority Data
Mar. 18, 2010 (JP) 2010-062863

(51) Int. Cl. G11B 7/00

(52) U.S. Cl. 369/103; G9B/7

(57) ABSTRACT

A holographic recording method includes the following steps:
irradiating an optical recording medium with a coherent reference beam and a coherent information beam to produce a hologram in the optical recording medium while irradiating the optical recording medium with an incoherent pretreatment beam to consume a polymerization inhibitor;
irradiating the hologram with the reference beam to extract a reproduction beam while stopping irradiating the optical recording medium with the reference beam;
sensing the signal beam with an image pick-up unit to detect an intensity of the signal beam; and
calculating a bit error rate with a control unit to irradiate the hologram with the information beam if the bit error rate is larger than a prescribed value, or to stop irradiating the optical recording medium with the reference beam, the information beam and the pretreatment beam if the bit error rate is smaller than the prescribed value.

### CROSS REFERENCE TO RELATED APPLICATION

This application is based upon and claims the benefit of priority from the prior Japanese Patent Application No. 2010-062863, filed on Mar. 18, 2010, the entire contents of which are incorporated herein by reference.

### FIELD

An embodiment relates generally to a holographic recording method.

### BACKGROUND

A published Japanese translation 2009-530676 of PCT international publication WO2007/107439 for patent applications discloses a method of using coherence light as pretreatment light and posttreatment light for a holographic recording medium including a sensitive material such as a photopolymer. Hereinafter, the holographic recording medium is referred to as the “optical recording medium”. Here, the pretreatment light is employed to enhance the sensitivity of the photopolymer. The posttreatment light is needed in order to develop a complete reaction of the unreacted photopolymer left after recording.

However, there is a possibility that the recording density of the optical recording medium is lower just for the pretreatment light irradiation thereto.

### BRIEF DESCRIPTION OF DRAWINGS

Aspects of this disclosure will become apparent upon reading the following detailed description and upon reference to accompanying drawings. The description and the associated drawings are provided to illustrate embodiments of the invention and not limited to the scope of the invention.

FIG. 1 is a view showing a holographic recording/readout system according to an embodiment.

FIG. 2 is a view showing a structure of an optical recording medium.

FIG. 3 is a view showing axes of coordinates for the optical recording medium.

FIG. 4 is a flow chart explaining a holographic recording method according to the embodiment.

### DESCRIPTION

As will be described below, according to an embodiment, a holographic recording method includes the following steps:

a step of irradiating an optical recording medium with a coherent reference beam and a coherent information beam to produce a hologram in the optical recording medium while irradiating the optical recording medium with an incoherent pretreatment beam to consume a polymerization inhibitor;

a step of irradiating the hologram produced in the optical recording medium with the reference beam to extract a reproduction beam while stopping irradiating the optical recording medium with the reference beam;

a step of sensing the signal beam with an image pick-up unit to detect an intensity of the signal beam; and

a step of calculating a bit error rate with a control unit to be connected to the image pick-up unit to irradiate the hologram produced in the optical recording medium with the information beam if the bit error rate is larger than a prescribed value, or to stop irradiating the optical recording medium with the reference beam, the information beam and the pretreatment beam if the bit error rate is smaller than the prescribed value.

The embodiment will be described in detail with reference to drawings below. Wherever possible, the same numerals or marks will be used to denote the same or like portions throughout figures, and overlapped explanations may be omitted.

### EMBODIMENT

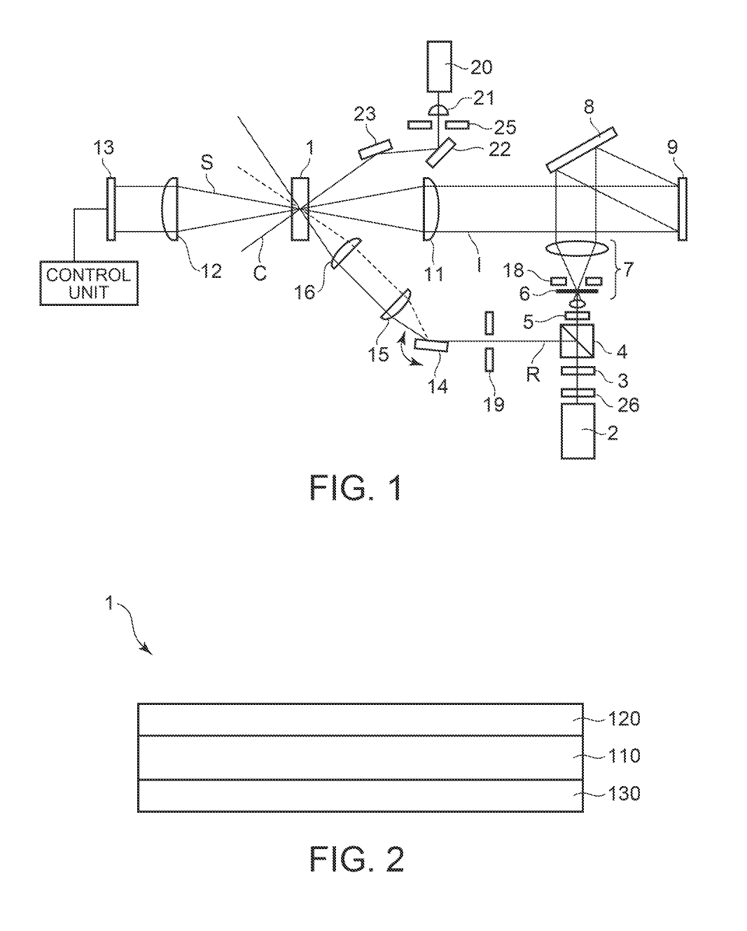

FIG. 1 is a schematic view showing a holographic recording/readout system according to the embodiment.

The holographic recording/readout system includes an optical recording medium 1, light sources 2, 20, elements 3, 5 for optical rotation, a polarized beam splitter 4, a pinhole 6, a spatial filter 7, mirrors 8, 14, 22, 23, a spatial beam modulator 9, lenses 11, 12, 15, 16, 21, an image pick-up unit 13, shutters 18, 19, 25, and an aperture 26. Alternatively, the aperture 26 is not necessarily provided to the holographic recording/readout system. The spatial filter 7 includes a lens, a pinhole, and a shutter. The special filter 7 eliminates a wave face noise or a distortion of a laser beam to make a clear wave face.

The light source 2 emits a coherent laser beam. The beam emitted from the light source 2 is allowed to react with a photopolymer included in the optical recording medium 1. A green or violet-blue semiconductor laser is employed for the light source 2 in combination with an external resonator (not shown) to stabilize the wavelength thereof. Specifically, an InGaN series violet-blue laser can be employed, which has a wavelength of 405 nm. Alternatively, other lasers having different wavelengths, so called a DFB laser, an SHG laser, a solid-state laser and a gas laser, etc. may be employed.

The light beam (referred to as the “beam” hereinafter) emitted from the light source 20 is used to consume the polymerization inhibitor contained in the optical recording medium 1. This beam is called a pretreatment beam C in the embodiment. A photopolymer is contained in the optical recording medium 1. Recording is performed by the reaction of the photopolymer. However, there is a possibility that an unintended reaction may occur as a result of natural light irradiation. Moreover, radicals are generated owing to heat also at high ambient temperatures, thereby promoting the polymerization. The polymerization inhibitor is contained in the optical recording medium 1 in order to control the unintended polymerization.

Direct irradiation of a coherent laser beam to the optical recording medium 1 for the consumption of the polymerization inhibitor causes fine scattering and interference of the laser beam in the optical recording medium 1. This results in a fine hologram as a noise. For this reason, an incoherent LED (Light Emitting Diode), for example, is employed for the light source 20. Specifically, it is possible to employ an ultraviolet or near-ultraviolet light source such as Super Flux ultraviolet LED having a wavelength of 390 nm to 412 nm.

The elements 3, 5 for optical rotation change a linear polarized beam into a circular beam. A half- or quarter-wavelength plate, for example, is employed for the elements 3, 5 for optical rotation.

A polarized beam splitter 4 separates a polarization light component from light to pass the component therethrough, thereby reflecting a portion of the light. The polarized beam splitter 4 divides a beam emitted from the light source 2 into an information beam I and a reference beam R. The reference beam R is employed as a signal beam S to perform readout from the optical recording medium 1.

The spatial beam modulator 9 modulates an incident beam into a grid binary pattern with bright and dark points to produce the information beam I. A liquid crystal device, a digital micromirror device and a reflection type FLCOS (Ferroelectric Liquid Crystal On Silicon), etc. can be employed for the spatial beam modulator 9. The spatial beam modulator 9 can switch passing and blocking of a beam.

The image pick-up unit 13 senses a beam intensity and a piece of information of the signal beam S. A bisected or quartered image pick-up unit can be employed for the image pick-up unit 13, for example. Alternatively, a CCD (Charge Coupled Device) sensor and a CMOS (Complementary Metal Oxide Semiconductor) sensor may be employed. A beam which is incident on the image pick-up unit 13 is adjusted so that the beam is incident on the center of the image pick-up unit 13. Furthermore, a control unit is connected to the image pick-up unit 13. The control unit processes the piece of information sensed by the image pick-up unit 13. The control unit is provided with a CPU and a database, and controls recording/calculating if needed.

An aperture 26 lowers the intensity of the beam emitted from the light source 2. This is to suppress a fine hologram causing a noise. A variable attenuator, a variable transformation neutral density filter in some cases can be employed for the aperture 26, for example.

The optical recording medium 1 is of transparent type, and is provided with a holographic recording material 110 sandwiched between two substrates 120 and 130, as shown in FIG. 2. Moreover, the shape of the optical recording medium 1 is preferably of disc type or of card type, etc. However, the shape is not limited to these.

Glass, polycarbonate, acrylic resin, etc. can be employed for the substrates 120 and 130, for example.

The holographic recording material 110 allows it to cause interference between the information beam I and the reference beam R, thereby forming a hologram therein. Examples of the holographic recording material 110 include a radical polymerizable monomer, a photoinitiator, a matrix material, and a polymerization inhibitor. These materials are formed as a material of radical polymerization type, which is called a photopolymer.

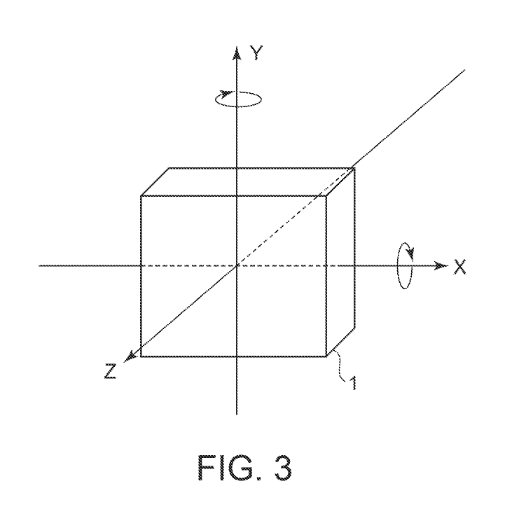

In this embodiment, as shown in FIG. 3, xyz axes of coordinates are taken for the optical recording medium 1. The z axis is taken as a thickness direction of the optical recording medium 1. Here, the directions of the x-axis and the y-axis are in in-plane directions of the optical recording medium 1. Alternatively, the optical recording medium 1 may be discal or rectangular as shown in FIG. 3. A crystal of lithium niobate can be employed for a rectangular optical recording medium 1. A photopolymer can be employed for a discal optical recording medium 1.

An operating principle of the holographic recording/readout system will be explained below.

On readout, a beam emitted from the light source 2 is extracted by the polarization beam splitter 4 as the reference beam R, and is directed to the optical recording medium 1 through the mirror 14. The signal beam S extracted from the recording medium 1 is led to the image pick-up unit 13.

On recording, a beam emitted from the light source 2 is extracted by the polarization beam splitter 4 as the reference beam R, and is directed to the optical recording medium 1 through the mirror 14. At the same time, a beam emitted from the light source 2 is extracted as the information beam I by the spatial beam modulator 9, and is directed to the optical recording medium 1 through the lens 11. At this time, the reference beam R and the information beam I are interfered with each other to be recorded on the optical recording medium 1 as interference fringes (also called a hologram).

This hologram is a modulation pattern of the information beam I to be stored in the optical recording medium 1, and is based on the grid binary pattern with bright and dark points formed with the spatial beam modulator 9. This binary pattern is called page data corresponding to a minimum unit of recording/readout.

Recording means a series of operations which give pieces of information to the optical recording medium 1 which is writable. Readout means a series of operations which read out pieces of information from the optical recording medium 1 which has been already recorded and is not writable.

This embodiment employs a two-beam optical system which irradiates the optical recording medium 1 with the information beam I and the reference beam R through separate lenses, etc. Moreover, this embodiment employs an angle multiple-recording mode to record by rotating the optical recording medium 1 around the y axis.

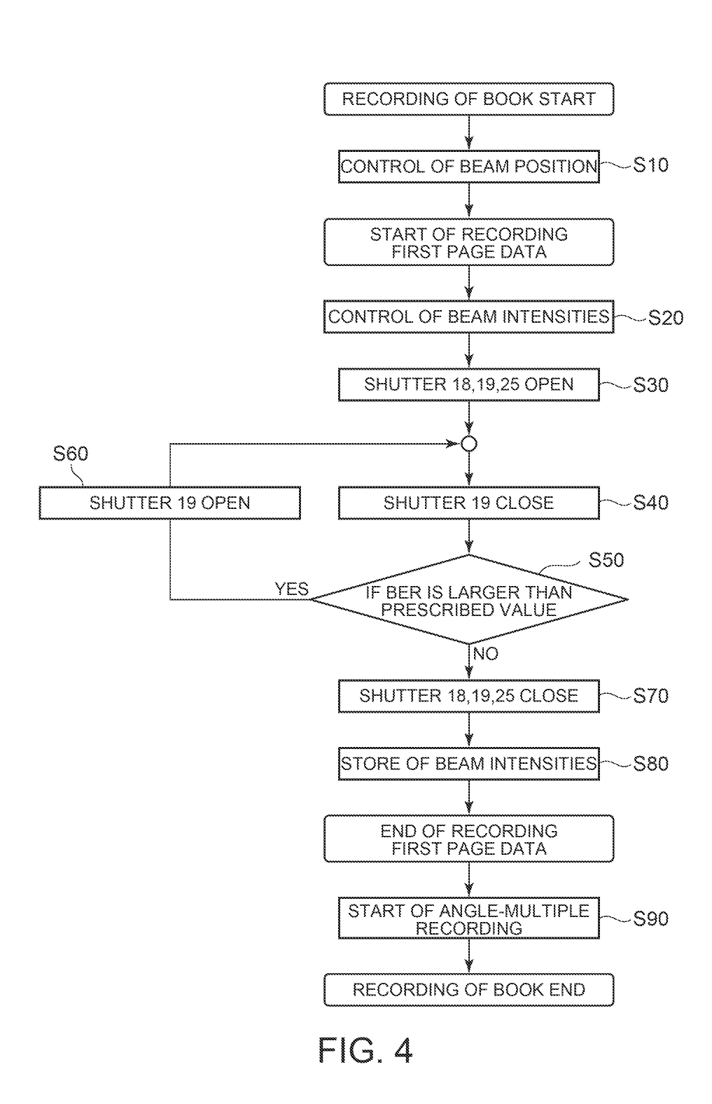

FIG. 4 is a flow chart showing a recording method of the holographic recording/readout system according to this embodiment.

At the step S10, a controlling drive unit (not shown) moves the reference beam R, the information beam I, and the pretreatment beam C to a region for the angle multiple-recording (referred to as a “book” hereinafter) on the optical recording medium 1, where a first page data are to be recorded. For example, a servo signal can be recorded beforehand in the optical recording medium 1 to be used on moving the beams, thereby allowing it to move the beams to a prescribed book. Moreover, the same position of the optical recording medium 1 is irradiated with the reference beam R, the information beam I, and the pretreatment beam C.

At the step S20, the respective intensities of the reference beam R, the information beam I, and the pretreatment beam C are adjusted to record first page data. Specifically, the intensities of the reference beam R and the information beam I are lowered using the aperture 26. This is because there is a possibility that the coherent reference beam R and the coherent information beam I are directed to the optical recording medium 1 to cause interference therebetween. This interference will produce a hologram to cause a noise in the optical recording medium 1. Alternatively, if there is not the possibility, the step S20 may be skipped.

At the step S30, the shutters 18, 19 and 25 are opened to irradiate the optical recording medium 1 with the reference beam R, the information beam I, and the pretreatment beam C. The pretreatment beam C is to consume the polymerization inhibitor contained in the optical recording medium 1. The polymerization inhibitor is consumed to produce a hologram as a result of the interference between the information beam I and the reference beam R. Here, the reference beam R and the information beam I can produce a hologram in the optical recording medium 1 owing to their coherencies. However, the pretreatment beam C has no coherency to interfere with the reference beam R or the information beam I, thereby producing no hologram.

At the step S40, the shutter 19 is closed to stop the irradiation of the information beam I, i.e., the holographic recording. Even in case that the shutter 19 is closed, the optical recording medium 1 is still irradiated with the pretreatment beam C and the reference beam R. The pretreatment beam C has already consumed the polymerization inhibitor in the optical recording medium 1. Then, a hologram is produced in the optical recording medium 1. At this time, the reference beam R is directed to the hologram so that the signal beam S is extracted from the optical recording medium 1. The image pick-up unit 13 senses the signal beam S. From pieces of information involved in the signal beam S, the control unit calculates BER (Bit Error Rate) and page data. BER means a ratio of error data to signal data.

At the step S50, the control unit judges whether BER calculated therein meets a prescribed value. Specifically, the control unit judges whether BER is larger than the prescribed value, e.g., 10⁻¹⁴. If BER is larger than the prescribed value, the recording process goes to the step S60, the shutter 19 is opened again to irradiate the optical recording medium 1 with the information beam I. If BER is smaller than the prescribed value, the control unit can judge the first page data to be recorded in the optical recording medium 1, thereby making the recording process go to the step S70.

As mentioned above, the holographic recording is performed with the reference beam R and the information beam I while judging whether the polymerization initiator has been consumed by the pretreatment beam C. Therefore, employing the pretreatment beam C allows it to prevent a reduction in the recording density of the optical recording medium 1 and to prevent the production of a hologram which causes a noise.

At the step S70, the shutters 18, 19 and 25 are closed to stop the irradiation of the reference beam R, the information beam I, and the pretreatment beam C.

If the control unit judges that BER meets the prescribed value at the step S80, the information about the respective intensities of the reference beam R, the information beam I, and the pretreatment beam C is stored in the control unit. This is to use the information when using the optical recording medium in the next recording performance. Alternatively, the step S80 may be skipped. The above-mentioned steps complete the recording of the first page data.

At the step S90, the angle multiple-recording is performed in series to record two or more page data while rotating the optical recording medium 1 around the y axis by a prescribed increment of rotating angle. In this case, the prescribed increment of rotating angle is not more than, e.g., 0.1°, provided that the thickness of the optical recording medium 1 is about 1.5 mm. Rotating the optical recording medium 1 by a prescribed total rotating angle completes the recording of book. In order to record another book, the recording process steps from S10 to S90 again.

In this embodiment, the holographic recording/readout system has been explained assuming that the employed optical recording medium is transparent. However, the holographic recording/readout system is not limited to this, and may employ an optical recording medium of reflection type.

The holographic recording method in accordance with this embodiment enables it to prevent a reduction in the recoding density of the optical recording medium and the production of a hologram which causes a noise.

While a certain embodiment of the invention has been described, the embodiment has been presented by way of examples only, and is not intended to limit the scope of the inventions. Indeed, the novel elements and apparatuses described herein may be embodied in a variety of other forms; furthermore, various omissions, substitutions and changes in the form of the methods described herein may be made without departing from the spirit of the invention. The accompanying claims and their equivalents are intended to cover such forms or modifications as would fall within the scope and spirit of the invention.

What is claimed is:

1. A holographic recording method comprising:
irradiating an optical recording medium with a coherent reference beam and a coherent information beam to produce a hologram in the optical recording medium while irradiating the optical recording medium with an incoherent pretreatment beam to consume a polymerization inhibitor contained therein;
irradiating the hologram produced in the optical recording medium with the reference beam to extract a signal beam while stopping irradiating the optical recording medium with the reference beam;
sensing the signal beam with an image pick-up unit to detect an intensity of the signal beam; and
calculating a bit error rate with a control unit to be connected to the image pick-up unit to irradiate the hologram produced in the optical recording medium with the information beam if the bit error rate is larger than a prescribed value, or to stop irradiating the optical recording medium with the reference beam, the information beam and the pretreatment beam if the bit error rate is smaller than the prescribed value.

2. The method according to claim 1, further comprising a step of rotating the optical recording medium around an axis lying in a plane of the optical recording medium to perform angle multiple-recording onto the optical recording medium with the information beam and the reference beam.

3. The method according to claim 1, wherein beam intensities of the information beam and the reference beam are lowered by an aperture.

4. The method according to claim 1, wherein wavelengths of the information beam and the reference beam are shorter than a wavelength of the pretreatment beam.
